(19) United States
(12) Patent Application Publication
(10) Pub. No.: US 2026/0122667 A1
(43) Pub. Date: Apr. 30, 2026

(54) PRIORITIZED BIT RATE BASED SLICING CONTROL

(71) Applicant: Nokia Solutions and Networks Oy, Espoo (FI)

(72) Inventors: Dingwen YUAN, Ulm (DE); Dereje KIFLE, Ulm (DE); Prasanna MUDLAPPA, Bangalore (IN); Jie Feng JIN, Hangzhou (CN); Thomas STARK, Ulm (DE)

(21) Appl. No.: 19/165,812

(22) PCT Filed: Mar. 16, 2023
(86) PCT No.: PCT/CN2023/081898

§ 371 Date: Sep. 16, 2025

(51) Int. Cl. H04W 72/566; H04W 72/1268

(52) U.S. Cl. CPC H04W 72/569; H04W 72/1268

(57) ABSTRACT

Disclosed is a method comprising determining an expected prioritized bit rate per a logical channel of one or more logical channels based at least on a spectral efficiency of at least one user device and a target share of a slice, the at least one user device being configured to communicate with the slice via the logical channel, wherein the target share indicates an expected proportion of radio resources allocated for the slice in a cell divided into a plurality of slices; and transmitting, to the at least one user device, a message indicating at least the expected prioritized bit rate per the logical channel of the one or more logical channels.

### FIELD

The following example embodiments relate to wireless communication and to network slicing.

### BACKGROUND

Network slicing is a technique that may be used in communication networks to create multiple logical networks (or “slices”) on top of a single physical network infrastructure.

### BRIEF DESCRIPTION

The scope of protection sought for various example embodiments is set out by the independent claims. The example embodiments and features, if any, described in this specification that do not fall under the scope of the independent claims are to be interpreted as examples useful for understanding various embodiments.

According to an aspect, there is provided an apparatus comprising at least one processor, and at least one memory storing instructions that, when executed by the at least one processor, cause the apparatus at least to: determine an expected prioritized bit rate per a logical channel of one or more logical channels based at least on a spectral efficiency of at least one user device and a target share of a slice, the at least one user device being configured to communicate with the slice via the logical channel, wherein the target share indicates an expected proportion of radio resources allocated for the slice in a cell divided into a plurality of slices; and transmit, to the at least one user device, a message indicating at least the expected prioritized bit rate per the logical channel of the one or more logical channels.

According to another aspect, there is provided an apparatus comprising: means for determining an expected prioritized bit rate per a logical channel of one or more logical channels based at least on a spectral efficiency of at least one user device and a target share of a slice, the at least one user device being configured to communicate with the slice via the logical channel, wherein the target share indicates an expected proportion of radio resources allocated for the slice in a cell divided into a plurality of slices; and means for transmitting, to the at least one user device, a message indicating at least the expected prioritized bit rate per the logical channel of the one or more logical channels.

According to another aspect, there is provided a method comprising: determining an expected prioritized bit rate per a logical channel of one or more logical channels based at least on a spectral efficiency of at least one user device and a target share of a slice, the at least one user device being configured to communicate with the slice via the logical channel, wherein the target share indicates an expected proportion of radio resources allocated for the slice in a cell divided into a plurality of slices; and transmitting, to the at least one user device, a message indicating at least the expected prioritized bit rate per the logical channel of the one or more logical channels.

According to another aspect, there is provided a computer program comprising instructions which, when executed by an apparatus, cause the apparatus to perform at least the following: determining an expected prioritized bit rate per a logical channel of one or more logical channels based at least on a spectral efficiency of at least one user device and a target share of a slice, the at least one user device being configured to communicate with the slice via the logical channel, wherein the target share indicates an expected proportion of radio resources allocated for the slice in a cell divided into a plurality of slices; and transmitting, to the at least one user device, a message indicating at least the expected prioritized bit rate per the logical channel of the one or more logical channels.

According to another aspect, there is provided a computer readable medium comprising program instructions which, when executed by an apparatus, cause the apparatus to perform at least the following: determining an expected prioritized bit rate per a logical channel of one or more logical channels based at least on a spectral efficiency of at least one user device and a target share of a slice, the at least one user device being configured to communicate with the slice via the logical channel, wherein the target share indicates an expected proportion of radio resources allocated for the slice in a cell divided into a plurality of slices; and transmitting, to the at least one user device, a message indicating at least the expected prioritized bit rate per the logical channel of the one or more logical channels.

According to another aspect, there is provided a non-transitory computer readable medium comprising program instructions which, when executed by an apparatus, cause the apparatus to perform at least the following: determining an expected prioritized bit rate per a logical channel of one or more logical channels based at least on a spectral efficiency of at least one user device and a target share of a slice, the at least one user device being configured to communicate with the slice via the logical channel, wherein the target share indicates an expected proportion of radio resources allocated for the slice in a cell divided into a plurality of slices; and transmitting, to the at least one user device, a message indicating at least the expected prioritized bit rate per the logical channel of the one or more logical channels.

According to another aspect, there is provided an apparatus comprising at least one processor, and at least one memory storing instructions that, when executed by the at least one processor, cause the apparatus at least to: receive a message indicating at least an expected prioritized bit rate per a logical channel of one or more logical channels; and configure the one or more logical channels by applying at least the expected prioritized bit rate per the logical channel of the one or more logical channels, wherein the expected prioritized bit rate is based at least on a spectral efficiency of the apparatus and a target share of a slice, the apparatus being configured to communicate with the slice via the logical channel, wherein the target share indicates an expected proportion of radio resources allocated for the slice in a cell divided into a plurality of slices.

According to another aspect, there is provided an apparatus comprising: means for receiving a message indicating at least an expected prioritized bit rate per a logical channel of one or more logical channels; and means for configuring the one or more logical channels by applying at least the expected prioritized bit rate per the logical channel of the one or more logical channels, wherein the expected prioritized bit rate is based at least on a spectral efficiency of the apparatus and a target share of a slice, the apparatus being configured to communicate with the slice via the logical channel, wherein the target share indicates an expected proportion of radio resources allocated for the slice in a cell divided into a plurality of slices.

According to another aspect, there is provided a method comprising: receiving, by an apparatus, a message indicating at least an expected prioritized bit rate per a logical channel of one or more logical channels; and configuring, by the apparatus, the one or more logical channels by applying at least the expected prioritized bit rate per the logical channel of the one or more logical channels, wherein the expected prioritized bit rate is based at least on a spectral efficiency of the apparatus and a target share of a slice, the apparatus being configured to communicate with the slice via the logical channel, wherein the target share indicates an expected proportion of radio resources allocated for the slice in a cell divided into a plurality of slices.

According to another aspect, there is provided a computer program comprising instructions which, when executed by an apparatus, cause the apparatus to perform at least the following: receiving a message indicating at least an expected prioritized bit rate per a logical channel of one or more logical channels; and configuring the one or more logical channels by applying at least the expected prioritized bit rate per the logical channel of the one or more logical channels, wherein the expected prioritized bit rate is based at least on a spectral efficiency of the apparatus and a target share of a slice, the apparatus being configured to communicate with the slice via the logical channel, wherein the target share indicates an expected proportion of radio resources allocated for the slice in a cell divided into a plurality of slices.

According to another aspect, there is provided a computer readable medium comprising program instructions which, when executed by an apparatus, cause the apparatus to perform at least the following: receiving a message indicating at least an expected prioritized bit rate per a logical channel of one or more logical channels; and configuring the one or more logical channels by applying at least the expected prioritized bit rate per the logical channel of the one or more logical channels, wherein the expected prioritized bit rate is based at least on a spectral efficiency of the apparatus and a target share of a slice, the apparatus being configured to communicate with the slice via the logical channel, wherein the target share indicates an expected proportion of radio resources allocated for the slice in a cell divided into a plurality of slices.

According to another aspect, there is provided a non-transitory computer readable medium comprising program instructions which, when executed by an apparatus, cause the apparatus to perform at least the following: receiving a message indicating at least an expected prioritized bit rate per a logical channel of one or more logical channels; and configuring the one or more logical channels by applying at least the expected prioritized bit rate per the logical channel of the one or more logical channels, wherein the expected prioritized bit rate is based at least on a spectral efficiency of the apparatus and a target share of a slice, the apparatus being configured to communicate with the slice via the logical channel, wherein the target share indicates an expected proportion of radio resources allocated for the slice in a cell divided into a plurality of slices.

According to another aspect, there is provided a system comprising at least one user device and a network node of a radio access network. The network node is configured to: determine an expected prioritized bit rate per a logical channel of one or more logical channels based at least on a spectral efficiency of the at least one user device and a target share of a slice, the at least one user device being configured to communicate with the slice via the logical channel, wherein the target share indicates an expected proportion of radio resources allocated for the slice in a cell divided into a plurality of slices; and transmit, to the at least one user device, a message indicating at least the expected prioritized bit rate per the logical channel of the one or more logical channels. The at least one user device is configured to: receive the message indicating at least the expected prioritized bit rate per the logical channel of the one or more logical channels; and configure the one or more logical channels by applying at least the expected prioritized bit rate per the logical channel of the one or more logical channels.

According to another aspect, there is provided a system comprising at least one user device and a network node of a radio access network. The network node comprises: means for determining an expected prioritized bit rate per a logical channel of one or more logical channels based at least on a spectral efficiency of the at least one user device and a target share of a slice, the at least one user device being configured to communicate with the slice via the logical channel, wherein the target share indicates an expected proportion of radio resources allocated for the slice in a cell divided into a plurality of slices; and means for transmitting, to the at least one user device, a message indicating at least the expected prioritized bit rate per the logical channel of the one or more logical channels. The at least one user device comprises: means for receiving the message indicating at least the expected prioritized bit rate per the logical channel of the one or more logical channels; and means for configuring the one or more logical channels by applying at least the expected prioritized bit rate per the logical channel of the one or more logical channels.

### LIST OF DRAWINGS

In the following, various example embodiments will be described in greater detail with reference to the accompanying drawings, in which

FIG. 1 illustrates an example of a wireless communication network;

FIG. 2 illustrates an example of a system;

FIG. 3 illustrates examples of logical channels;

FIG. 4 illustrates a signal flow diagram;

FIG. 5 illustrates a flow chart;

FIG. 6 illustrates a flow chart;

FIG. 7 illustrates a flow chart;

FIG. 8 illustrates an example of an apparatus; and

FIG. 9 illustrates an example of an apparatus.

### DETAILED DESCRIPTION

The following embodiments are exemplifying. Although the specification may refer to “an”, “one”, or “some” embodiment(s) in several locations of the text, this does not necessarily mean that each reference is made to the same embodiment(s), or that a particular feature only applies to a single embodiment. Single features of different embodiments may also be combined to provide other embodiments.

Some example embodiments described herein may be implemented in a wireless communication network comprising a radio access network based on one or more of the following radio access technologies: Global System for Mobile Communications (GSM) or any other second generation radio access technology, Universal Mobile Telecommunication System (UMTS, 3G) based on basic wideband-code division multiple access (W-CDMA), high-speed packet access (HSPA), Long Term Evolution (LTE), LTE-Advanced, fourth generation (4G), fifth generation (5G), 5G new radio (NR), 5G-Advanced (i.e., 3GPP NR Rel-18 and beyond), or sixth generation (6G). Some examples of radio access networks include the universal mobile telecommunications system (UMTS) radio access network (UTRAN), the Evolved Universal Terrestrial Radio Access network (E-UTRA), or the next generation radio access network (NG-RAN). The wireless communication network may further comprise a core network, and some example embodiments may also be applied to network functions of the core network.

It should be noted that the embodiments are not restricted to the wireless communication network given as an example, but a person skilled in the art may also apply the solution to other wireless communication networks or systems provided with necessary properties. For example, some example embodiments may also be applied to a communication system based on IEEE 802.11 specifications, or a communication system based on IEEE 802.15 specifications.

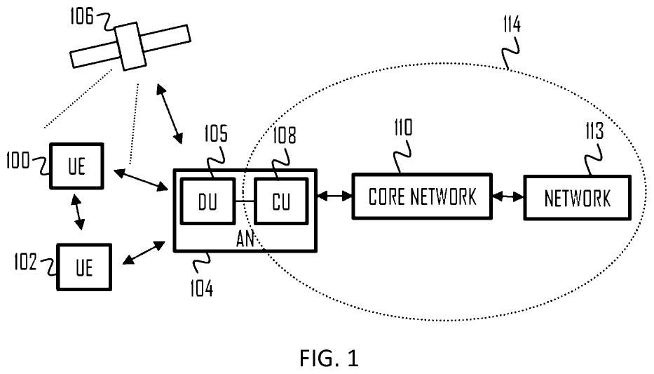

FIG. 1 depicts an example of a simplified wireless communication network showing some physical and logical entities. The connections shown in FIG. 1 may be physical connections or logical connections. It is apparent to a person skilled in the art that the wireless communication network may also comprise other physical and logical entities than those shown in FIG. 1.

The example embodiments described herein are not, however, restricted to the wireless communication network given as an example but a person skilled in the art may apply the embodiments described herein to other wireless communication networks provided with necessary properties.

The example wireless communication network shown in FIG. 1 includes an access network, such as a radio access network (RAN), and a core network 110.

FIG. 1 shows user equipment (UE) 100, 102 configured to be in a wireless connection on one or more communication channels in a radio cell with an access node (AN) 104 of an access network. The AN 104 may be an evolved Node B (abbreviated as eNB or eNodeB) or a next generation Node B (abbreviated as gNB or gNodeB), providing the radio cell. The wireless connection (e.g., radio link) from a UE to the access node 104 may be called uplink (UL) or reverse link, and the wireless connection (e.g., radio link) from the access node to the UE may be called downlink (DL) or forward link. UE 100 may also communicate directly with UE 102, and vice versa, via a wireless connection generally referred to as a sidelink (SL). It should be appreciated that the access node 104 or its functionalities may be implemented by using any node, host, server or access point etc. entity suitable for providing such functionalities.

The access network may comprise more than one access node, in which case the access nodes may also be configured to communicate with one another over links, wired or wireless. These links between access nodes may be used for sending and receiving control plane signaling and also for routing data from one access node to another access node.

The access node may comprise a computing device configured to control the radio resources of the access node. The access node may also be referred to as a base station, a base transceiver station (BTS), an access point, a radio access node or any other type of node capable of being in a wireless connection with a UE (e.g., UEs 100, 102). The access node may include or be coupled to transceivers. From the transceivers of the access node, a connection may be provided to an antenna unit that establishes bi-directional radio links to UEs 100, 102. The antenna unit may comprise an antenna or antenna element, or a plurality of antennas or antenna elements.

The access node 104 may further be connected to a core network (CN) 110. The core network 110 may comprise an evolved packet core (EPC) network and/or a 5th generation core network (5GC). The EPC may comprise network entities, such as a serving gateway (S-GW for routing and forwarding data packets), a packet data network gateway (P-GW) for providing connectivity of UEs to external packet data networks, and a mobility management entity (MME). The 5GC may comprise network functions, such as a user plane function (UPF), an access and mobility management function (AMF), and a location management function (LMF).

The core network 110 may also be able to communicate with one or more external networks 113, such as a public switched telephone network or the Internet, or utilize services provided by them. For example, in 5G wireless communication networks, the UPF of the core network 110 may be configured to communicate with an external data network via an N6 interface. In LTE wireless communication networks, the P-GW of the core network 110 may be configured to communicate with an external data network.

The illustrated UE 100, 102 is one type of an apparatus to which resources on the air interface may be allocated and assigned. The UE 100, 102 may also be called a wireless communication device, a subscriber unit, a mobile station, a remote terminal, an access terminal, a user terminal, a terminal device, or a user device just to mention but a few names. The UE may be a computing device operating with or without a subscriber identification module (SIM), including, but not limited to, the following types of computing devices: a mobile phone, a smartphone, a personal digital assistant (PDA), a handset, a computing device comprising a wireless modem (e.g., an alarm or measurement device, etc.), a laptop computer, a desktop computer, a tablet, a game console, a notebook, a multimedia device, a reduced capability (RedCap) device, a wearable device (e.g., a watch, earphones or eyeglasses) with radio parts, a sensor comprising a wireless modem, or any computing device comprising a wireless modem integrated in a vehicle.

Any feature described herein with a UE may also be implemented with a corresponding apparatus, such as a relay node. An example of such a relay node may be a layer 3 relay (self-backhauling relay) towards the access node. The self-backhauling relay node may also be called an integrated access and backhaul (IAB) node. The IAB node may comprise two logical parts: a mobile termination (MT) part, which takes care of the backhaul link(s) (i.e., link(s) between IAB node and a donor node, also known as a parent node) and a distributed unit (DU) part, which takes care of the access link(s), i.e., child link(s) between the IAB node and UE(s), and/or between the IAB node and other IAB nodes (multi-hop scenario).

Another example of such a relay node may be a layer 1 relay called a repeater. The repeater may amplify a signal received from an access node and forward it to a UE, and/or amplify a signal received from the UE and forward it to the access node.

It should be appreciated that a UE may also be a nearly exclusive uplink-only device, of which an example may be a camera or video camera loading images or video clips to a network. A UE may also be a device having capability to operate in an Internet of Things (IoT) network, which is a scenario in which objects may be provided with the ability to transfer data over a network without requiring human-to-human or human-to-computer interaction. The UE may also utilize cloud. In some applications, the computation may be carried out in the cloud or in another UE.

The wireless communication network may also be able to support the usage of cloud services, for example at least part of core network operations may be carried out as a cloud service (this is depicted in FIG. 1 by “cloud” 114). The communication system may also comprise a central control entity, or the like, providing facilities for wireless communication networks of different operators to cooperate for example in spectrum sharing.

Various techniques described herein may also be applied to a cyber-physical system (CPS) (a system of collaborating computational elements controlling physical entities). CPS may enable the implementation and exploitation of massive amounts of interconnected ICT devices (sensors, actuators, processors microcontrollers, etc.) embedded in physical objects at different locations. Mobile cyber physical systems, in which the physical system in question may have inherent mobility, are a subcategory of cyber-physical systems. Examples of mobile physical systems include mobile robotics and electronics transported by humans or animals.

5G enables using multiple input-multiple output (MIMO) antennas in the access node 104 and/or the UE 100, 102, many more base stations or access nodes than an LTE network (a so-called small cell concept), including macro sites operating in co-operation with smaller stations and employing a variety of radio technologies depending on service needs, use cases and/or spectrum available. 5G wireless communication networks may support a wide range of use cases and related applications including video streaming, augmented reality, different ways of data sharing and various forms of machine type applications, such as (massive) machine-type communications (mMTC), including vehicular safety, different sensors and real-time control.

In 5G wireless communication networks, access nodes and/or UEs may have multiple radio interfaces, namely below 6 GHz, cmWave and mmWave, and also being integrable with existing legacy radio access technologies, such as the LTE. Integration with the LTE may be implemented, for example, as a system, where macro coverage may be provided by the LTE, and 5G radio interface access may come from small cells by aggregation to the LTE. In other words, a 5G wireless communication network may support both inter-RAT operability (such as LTE-5G) and inter-RI operability (inter-radio interface operability, such as below 6 GHz-cmWave-mmWave). One of the concepts considered to be used in 5G wireless communication networks may be network slicing, in which multiple independent and dedicated virtual sub-networks (network instances) may be created within the substantially same infrastructure to run services that have different requirements on latency, reliability, throughput and mobility.

5G may enable analytics and knowledge generation to occur at the source of the data. This approach may involve leveraging resources that may not be continuously connected to a network, such as laptops, smartphones, tablets and sensors. Multi-access edge computing (MEC) may provide a distributed computing environment for application and service hosting. It may also have the ability to store and process content in close proximity to cellular subscribers for faster response time. Edge computing may cover a wide range of technologies, such as wireless sensor networks, mobile data acquisition, mobile signature analysis, cooperative distributed peer-to-peer ad hoc networking and processing also classifiable as local cloud/fog computing and grid/mesh computing, dew computing, mobile edge computing, cloudlet, distributed data storage and retrieval, autonomic self-healing networks, remote cloud services, augmented and virtual reality, data caching, Internet of Things (massive connectivity and/or latency critical), critical communications (autonomous vehicles, traffic safety, real-time analytics, time-critical control, healthcare applications).

In some example embodiments, an access node (e.g., access node 104) may comprise: a radio unit (RU) comprising a radio transceiver (TRX), i.e., a transmitter (Tx) and a receiver (Rx); one or more distributed units (DUs) 105 that may be used for the so-called Layer 1 (L1) processing and real-time Layer 2 (L2) processing; and a central unit (CU) 108 (also known as a centralized unit) that may be used for non-real-time L2 and Layer 3 (L3) processing. The CU 108 may be connected to the one or more DUs 105 for example via an F1 interface. Such an embodiment of the access node may enable the centralization of CUs relative to the cell sites and DUs, whereas DUs may be more distributed and may even remain at cell sites. The CU and DU together may also be referred to as baseband or a baseband unit (BBU). The CU and DU may also be comprised in a radio access point (RAP).

The CU 108 may be a logical node hosting radio resource control (RRC), service data adaptation protocol (SDAP) and/or packet data convergence protocol (PDCP), of the NR protocol stack for an access node. The DU 105 may be a logical node hosting radio link control (RLC), medium access control (MAC) and/or physical (PHY) layers of the NR protocol stack for the access node. The operations of the DU may be at least partly controlled by the CU. It should also be understood that the distribution of functions between DU 105 and CU 108 may vary depending on implementation. The CU may comprise a control plane (CU-CP), which may be a logical node hosting the RRC and the control plane part of the PDCP protocol of the NR protocol stack for the access node. The CU may further comprise a user plane (CU-UP), which may be a logical node hosting the user plane part of the PDCP protocol and the SDAP protocol of the CU for the access node.

Cloud computing systems may also be used to provide the CU 108 and/or DU 105. A CU provided by a cloud computing system may be referred to as a virtualized CU (vCU). In addition to the vCU, there may also be a virtualized DU (vDU) provided by a cloud computing system. Furthermore, there may also be a combination, where the DU may be implemented on so-called bare metal solutions, for example application-specific integrated circuit (ASIC) or customer-specific standard product (CSSP) system-on-a-chip (SoC).

Edge cloud may be brought into the access network (e.g., RAN) by utilizing network function virtualization (NFV) and software defined networking (SDN). Using edge cloud may mean access node operations to be carried out, at least partly, in a computing system operationally coupled to a remote radio head (RRH) or a radio unit (RU) of an access node. It is also possible that access node operations may be performed on a distributed computing system or a cloud computing system located at the access node. Application of cloud RAN architecture enables RAN real-time functions being carried out at the access network (e.g., in a DU 105) and non-real-time functions being carried out in a centralized manner (e.g., in a CU 108).

It should also be understood that the distribution of functions between core network operations and access node operations may differ in future wireless communication networks compared to that of the LTE or 5G, or even be non-existent. Some other technology advancements that may be used include big data and all-IP, which may change the way wireless communication networks are being constructed and managed. 5G (or new radio, NR) wireless communication networks may support multiple hierarchies, where multi-access edge computing (MEC) servers may be placed between the core network 110 and the access node 104. It should be appreciated that MEC may be applied in LTE wireless communication networks as well.

A 5G wireless communication network (“5G network”) may also comprise a non-terrestrial communication network, such as a satellite communication network, to enhance or complement the coverage of the 5G radio access network. For example, satellite communication may support the transfer of data between the 5G radio access network and the core network, enabling more extensive network coverage. Possible use cases may be providing service continuity for machine-to-machine (M2M) or Internet of Things (IoT) devices or for passengers on board of vehicles, or ensuring service availability for critical communications, and future railway/maritime/aeronautical communications. Satellite communication may utilize geostationary earth orbit (GEO) satellite systems, but also low earth orbit (LEO) satellite systems, in particular mega-constellations (systems in which hundreds of (nano) satellites are deployed). A given satellite 106 in the mega-constellation may cover several satellite-enabled network entities that create on-ground cells. The on-ground cells may be created through an on-ground relay access node or by an access node 104 located on-ground or in a satellite.

It is obvious for a person skilled in the art that the access node 104 depicted in FIG. 1 is just an example of a part of an access network (e.g., a radio access network) and in practice, the access network may comprise a plurality of access nodes, the UEs 100, 102 may have access to a plurality of radio cells, and the access network may also comprise other apparatuses, such as physical layer relay access nodes or other entities. At least one of the access nodes may be a Home eNodeB or a Home gNodeB. A Home gNodeB or a Home eNodeB is a type of access node that may be used to provide indoor coverage inside a home, office, or other indoor environment.

Additionally, in a geographical area of an access network (e.g., a radio access network), a plurality of different kinds of radio cells as well as a plurality of radio cells may be provided. Radio cells may be macro cells (or umbrella cells) which may be large cells having a diameter of up to tens of kilometers, or smaller cells such as micro-, femto- or picocells. The access node(s) of FIG. 1 may provide any kind of these cells. A cellular radio network may be implemented as a multilayer access networks including several kinds of radio cells. In multilayer access networks, one access node may provide one kind of a radio cell or radio cells, and thus a plurality of access nodes may be needed to provide such a multilayer access network.

For fulfilling the need for improving performance of access networks, the concept of “plug-and-play” access nodes may be introduced. An access network which may be able to use “plug-and-play” access nodes, may include, in addition to Home eNodeBs or Home gNodeBs, a Home Node B gateway, or HNB-GW (not shown in FIG. 1). An HNB-GW, which may be installed within an operator's access network, may aggregate traffic from a large number of Home eNodeBs or Home gNodeBs back to a core network of the operator.

6G wireless communication networks are expected to adopt flexible decentralized and/or distributed computing systems and architecture and ubiquitous computing, with local spectrum licensing, spectrum sharing, infrastructure sharing, and intelligent automated management underpinned by mobile edge computing, artificial intelligence, short-packet communication and blockchain technologies. Key features of 6G may include intelligent connected management and control functions, programmability, integrated sensing and communication, reduction of energy footprint, trustworthy infrastructure, scalability and affordability. In addition to these, 6G is also targeting new use cases covering the integration of localization and sensing capabilities into system definition to unifying user experience across physical and digital worlds.

Some services, such as enhanced mobile broadband (eMBB), massive machine-type communications (mMTC), ultra-reliable low latency communications (URLLC), etc., may be quite demanding with respect to high bandwidth, low latency and ultra-reliability. Network slicing is a technology enabler that may support these services simultaneously with service differentiation and guaranteed performance.

Network slicing is a technique that may be used in communication networks to create multiple logical networks (or “slices”) on top of a single physical network infrastructure. A given slice is a self-contained network with its own characteristics, such as bandwidth, latency, security, and quality of service (QoS), tailored to meet the needs of a specific set of users or applications. Network slicing allows network operators to optimize their resources and offer customized services to different types of customers. Thus, network slicing accommodates several independent logical networks for different business needs and service level agreement (SLA) requirements, while running on shared physical infrastructure. Network slicing may refer to RAN, transport, and core network slicing.

Some example embodiments relate to RAN slicing. RAN slicing is a technique in network slicing that allows multiple logical networks, or “slices”, to share a common physical RAN infrastructure. With RAN slicing, a network operator may be able to support multiple slices, for example public land mobile networks (PLMNs), with an agreed share of RAN resources indicated by the SLA, as well as customize the resources for a given traffic characteristic, service and SLA.

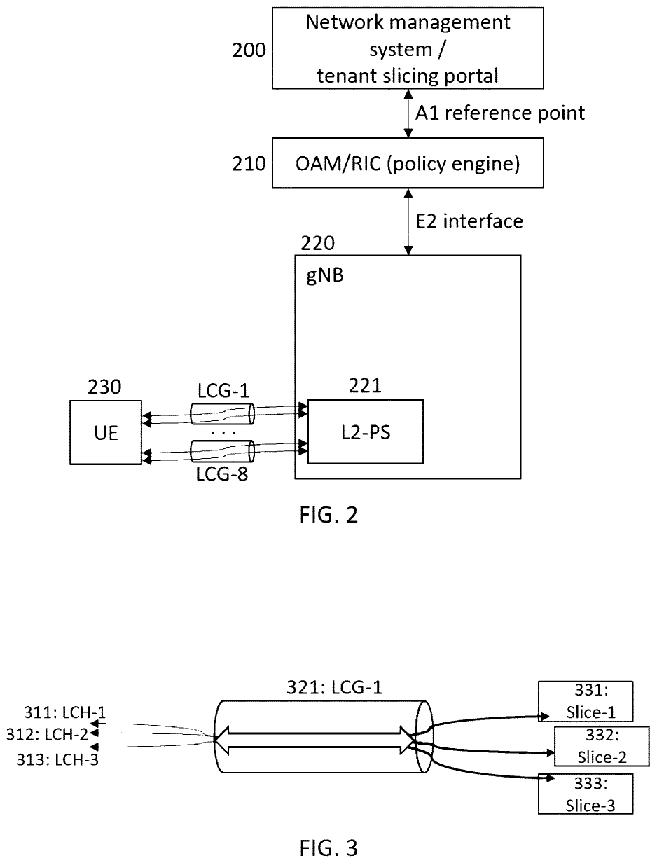

FIG. 2 illustrates an example of a network management system (tenant slicing portal system) 200 with a radio intelligent controller (RIC) 210, gNB 220, and a UE 230. The gNB 220 may correspond to the access node 104 of FIG. 1, and the UE 230 may correspond to UE 100 or 102 of FIG. 1.

The network management system (NMS) 200 is a centralized platform that enables operators to manage and monitor various network components, including RANs, core networks, and transport networks. The NMS provides a single interface through which operators can perform various tasks, such as provisioning new network services, configuring network components, monitoring network performance, and detecting and resolving network faults.

In this example, the NMS 200 may provide a tenant slicing portal. The tenant slicing portal is a web-based interface used to manage network slicing. The tenant slicing portal may be used by tenants, such as enterprise customers or third-party service providers, to request and configure network slices to meet their specific requirements. The tenant slicing portal provides a way for tenants to specify their slice requirements in terms of QoS, bandwidth, latency, and other parameters, and to monitor and manage their slices over time. Thus, the tenant slicing portal enables the dynamic creation, modification, and management of slices to meet the needs of diverse applications and services.

The RIC 210 is a network component that separates the control plane and data plane of the RAN to allow for more flexible and efficient network operations. The RIC 210 is responsible for implementing network policies and controlling radio resources, which enables the network to dynamically optimize its operations to support different use cases, services, and devices. The RIC 210 may interact with other network elements, such as the core network and edge computing resources, to orchestrate network services and functions.

Alternatively, the system may comprise an operations, administration, and maintenance (OAM) function instead of or in addition to the RIC 210. OAM refers to the set of processes, procedures, and tools used to manage and maintain a network. OAM allows network operators to monitor network performance, diagnose and resolve issues, and perform maintenance tasks. OAM functions may include fault management, performance management, security management, and configuration management.

The layer-2 packet scheduler (L2-PS) 221 in the gNB 220 has the responsibility of allocating radio resources in UL and DL and it may enforce volume control of RAN slice resources. Currently, when requesting resources from the gNB 220, the UE 230 may not report the logical channel (LCH) identifier(s) for which it is requesting resources. Instead, the requests may be made at logical channel group (LCG) level. Currently, the L2-PS 221 may be unable to send uplink grants from the respective slices, when the UE 230 sends resource requests for multiple channels in the same logical channel group (LCG) (e.g., LCG-1 in FIG. 2). Thus, the UE 230 may not consider any slicing quotas, when assigning uplink grants.

Logical channels or channels referred to herein represent data radio bearers (DRBs). A DRB is a logical connection that enables the transfer of data between the UE 230 and the gNB 220 in a cellular network. For example, a DRB may carry user data, such as voice, video, and internet traffic, between the UE 230 and the gNB 220.

FIG. 3 illustrates examples of logical channels 311, 312, 313 and a logical channel group 321 between the UE 230 and the gNB 220. A logical channel group 321 (e.g., LCG-1) comprises multiple different logical channels 311, 312, 313 (e.g., LCH-1, LCH-2, and LCH-3).

While it may be relatively simple to enforce slice volume or quota control in downlink, there are two inherent challenges when it comes to slice-aware scheduling in uplink.

The first challenge is that the UE 230 may send a scheduling request (SR) to the gNB 220 for requesting uplink shared channel (UL-SCH) resources (uplink grants) for a new transmission. Buffer status reports (BSR) sent by the UE 230 to the serving gNB 220 provide details on the amount of data waiting for transmission in the UL buffers at the UE 230. However, currently, there is no slice-specific information, such as single network slice selection assistance information (S-NSSAI) or logical channel identifier(s), in the SR or BSR sent by the UE 230 to the gNB 220, when requesting for uplink grants. In other words, the UE 230 does not send any slice-specific details (that the resources have to be allocated from that specific slice quota), when requesting for uplink grants. Different LCHs 311, 312, 313 may have their respective quotas in different slices 331, 332, 333, but that indication is not sent to the gNB 220, when requesting for uplink grants. Also, the buffer status (amount of data waiting at the UE 230 for grants) is at LCG level and not at per-LCH level.

The second challenge is that, currently, the allocation of uplink grants by the gNB 220 is at a per-UE level, in order to reduce the physical downlink control channel (PDCCH) overhead. Upon receiving uplink grants, the UE 230 selects bearer(s) for data transmission according to priorities and other parameters configured on the UE 230 by the gNB 220. In other words, the UE 230 uses the standardized logical channel prioritization procedure, which does not consider any network slicing aspects, when assigning uplink grants to transmit data in uplink. Furthermore, currently, the details regarding from which slice the resources were allocated by the gNB 220 is not communicated to the UE 230. Because of this behavior, there is currently no method available to enforce slice quota control in uplink direction.

The logical channel prioritization procedure may be used to prioritize the transmission of data over different logical channels. In this procedure, a given logical channel is assigned a priority value, which determines the order in which data from the channels is transmitted over the air interface. The priority values may be assigned based on the QoS requirements of the applications that use the logical channels. For example, a real-time application such as video streaming may be assigned a higher priority than a non-real-time application such as email, to ensure that the video data is transmitted with minimal delay and jitter.

In summary, according to the current procedure, when the UE 230 requests uplink grants from the gNB 220, the UE 230 does not specify for which particular logical channel it is requesting the uplink grants (as the requests are done at LCG level), and hence there is currently no direct way to map resource requests to slices to provide UL grants. To aggravate this problem, the UE 230 may use its own discretion (as per the logical channel prioritization procedure), when making use of the received uplink grants, and the UE 230 may not consider any slice-specific aspects. In other words, the uplink multiplexing is done according to a set of well-defined rules at the UE 230 (as per the logical channel prioritization procedure). Furthermore, when the gNB 220 grants resources, it does so at UE-level and does not enforce that the allocated resources have to be used for a particular logical channel belonging to a slice, from whose slice quota the resources were granted. These challenges make it difficult to manage and enforce slice-specific quotas to their respective logical channels in uplink.

Some example embodiments may address the above challenges and provide a method for efficient controlling of RAN slice resource quotas in uplink direction based on logical channel prioritized bit rate (PBR) reconfiguration within the scope of the LCP procedure. For example, some example embodiments may provide a mechanism for uplink slicing control via a medium access control (MAC) control element (CE) based logical channel reconfiguration of priority, PBR, and/or bucket size duration (BSD).

Prioritized bit rate is a logical channel configuration parameter, which may be used by the UE while allocating the received uplink grants to its logical channels as per the standardized logical channel prioritization procedure. PBR indicates the guaranteed minimum bit rate for a specific logical channel (i.e., DRB). PBR may be used in packet-based networks to ensure that certain types of traffic receive a certain level of service, and it may be used in conjunction with other QoS parameters such as latency, jitter, and packet loss. PBR may be defined in terms of a minimum bit rate, and the network (e.g., gNB) and the UE may attempt to allocate sufficient bandwidth to meet this requirement, subject to other constraints such as available network capacity and the priority of other traffic.

Bucket size duration refers to the length of time for which data is collected and analyzed for network traffic management purposes. The data may be collected in “buckets” of fixed duration, which may range from a few milliseconds to one second, and used in conjunction with the PBR to measure the bit rate. By analyzing these metrics, network operators can identify bottlenecks and congestion points in the network, and take steps to optimize network performance and improve the quality of service for end users.

For example, PBR may be reconfigured by using the RRC reconfiguration procedure. However, the RRC reconfiguration procedure may be inefficient (incurs a long delay) in the context of RAN slicing control, where it may be necessary to reconfigure the PBR more often based on the slice resource usage. Hence, a more efficient LCH reconfiguration may be provided based on MAC CE. Thus, some example embodiments may provide an efficient mechanism to adjust resource usage on the fly, as per the slice quotas in line with the SLAs.

To illustrate the use of PBR for uplink slicing control, let us assume the following system model. Multiple slices are configured in a cell, which means that the resources of the cell are sliced into different logical partitions that can be managed independently. A given slice is configured with a parameter called “target share”, which indicates the expected proportion of resources allocated for that slice in the cell. For example, the target share may be expressed as a percentage value in the range of 0 to 1 (0% to 100%). In other words, the target share of a given slice may represent the expected percentage of cell resources, i.e., a certain number of physical resource blocks (PRBs) that needs to be allocated to UEs or logical channels having their resource quota in the respective slice. The total target share of all slices in the cell amounts to 1.0 (100%). UL RAN slicing control may be achieved by shaping non-guaranteed bit rate (non-GBR) traffic, i.e., controlling the bit rate of non-GBR DRBs. It shall ensure that a given slice gets resources according to its target share (SLAs). When needed, the PBR may be reconfigured to influence the allocation of UL grants in the LCP procedure on the UE.

Guaranteed bit rate (GBR) refers to a minimum level of bandwidth or data rate that is guaranteed to be available to a user or service. In other words, GBR is an SLA between a network operator and a user, where the network operator guarantees that the user will have a certain level of bandwidth or data rate available to them at all times, regardless of network congestion or other factors. This is in contrast to non-GBR traffic, such as best-effort services, where the available bandwidth or data rate may vary depending on network conditions.

Some example embodiments are based on techniques called PRB efficiency measurement and PBR update.

PRB efficiency measurement regularly updates the system model between PRBs used and throughput for a given UE. In other words, this functionality determines the spectral efficiency of a given UE, which will be used for the PBR update. The spectral efficiency is a measure of the information rate that can be transmitted over a given bandwidth of a communication channel. For example, the spectral efficiency may be expressed in bits per second per hertz (bps/Hz).

The functionality of PBR update is to regularly determine the expected PBR for a given logical channel, so that every slice will achieve its target share in the long run. When the expected PBR of a logical channel needs to be changed to a higher or a lower level, the efficient PBR reconfiguration via MAC CE may be applied to notify the corresponding UE. The expected PBR of a logical channel may depend on at least one of: the weight of the logical channel, the resource (PRB) usage by GBR and non-GBR traffic of a given slice, the target share of a given slice, and the spectral efficiency of the UE.

Some example embodiments are described below using principles and terminology of 5G radio access technology without limiting the example embodiments to 5G radio access technology, however.

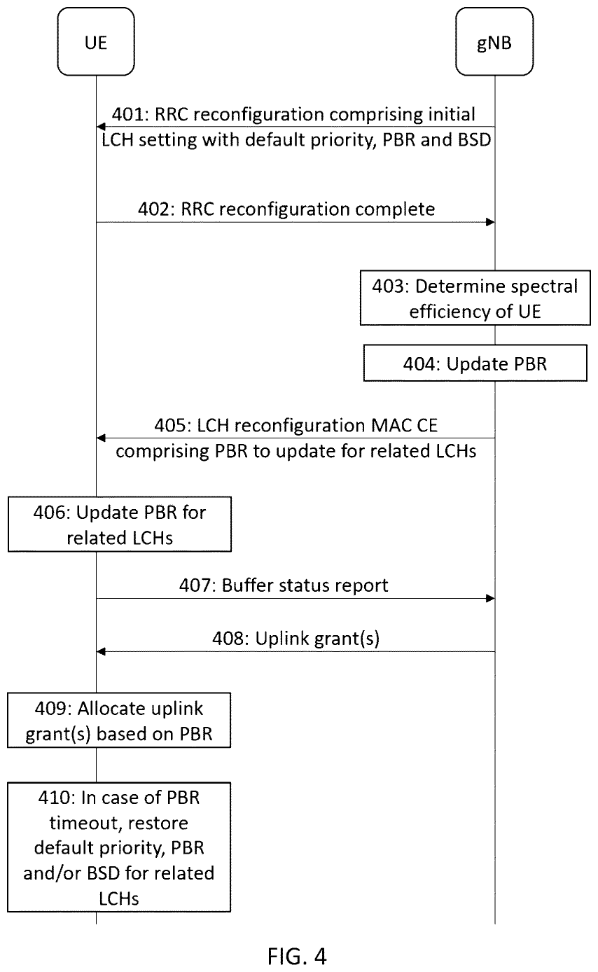

FIG. 4 illustrates a signal flow diagram according to an example embodiment for PBR-based uplink slicing control.

At 401, a gNB transmits, to a UE, an RRC reconfiguration message comprising an initial LCH setting with default priority, PBR and BSD. In other words, the UE may be configured to communicate with at least one slice via one or more logical channels. The gNB may correspond to the access node 104 of FIG. 1, or the gNB 220 of FIG. 2. The UE may correspond to UE 100 or 102 of FIG. 1, or the UE 230 of FIG. 2.

According to the current 3GPP standard, a given UE can be configured with up to 8 LCGs. For example, LCHs of traffic classes with similar priorities may be grouped into one LCG. As shown in the example of Table 1 below, LCGs may correspond to traffic classes of signaling, GBR (voice, video, etc.) and non-GBR. The traffic demand of signaling and GBR LCHs may be satisfied unconditionally. After that, if there are still cell resources available, the non-GBR LCHs will be scheduled and slicing controlled.

TABLE 1
Examples of logical channel groups

| LCG ID | Traffic class |
|---|---|
| 0 | Signaling and retransmissions |
| 1 & 2 | Non-GBR (5QI 5-9, 69-70, 79) |
| 3 | Non-GBR low latency (5QI 80) |
| 4 | Voice (5QI 1) |
| 5 | GBR (5QI 2-4, 65-67, 71-76) |
| 6 | URLLC GBR (5QI 2-4) |
| 7 | URLLC DC-GBR (5QI 82-86) |
| | Additionally, operator-defined 5QI (128-254) can be mapped to |
| | channels 1-3 and 4 (and possibly 6 and 7) |

In Table 1, 5QI is an abbreviation for “5G QoS identifier.” 5QI is a parameter that is used to indicate the priority and characteristics of a specific flow or service. The 5QI value may range from 1 to 255 and it may be used to map the flow or service to a particular QoS profile defined by the network operator. A given 5QI value may be associated with a specific set of QoS parameters, such as guaranteed bit rate, maximum bit rate, and packet delay budget, that determine the quality of service that the flow or service will receive.

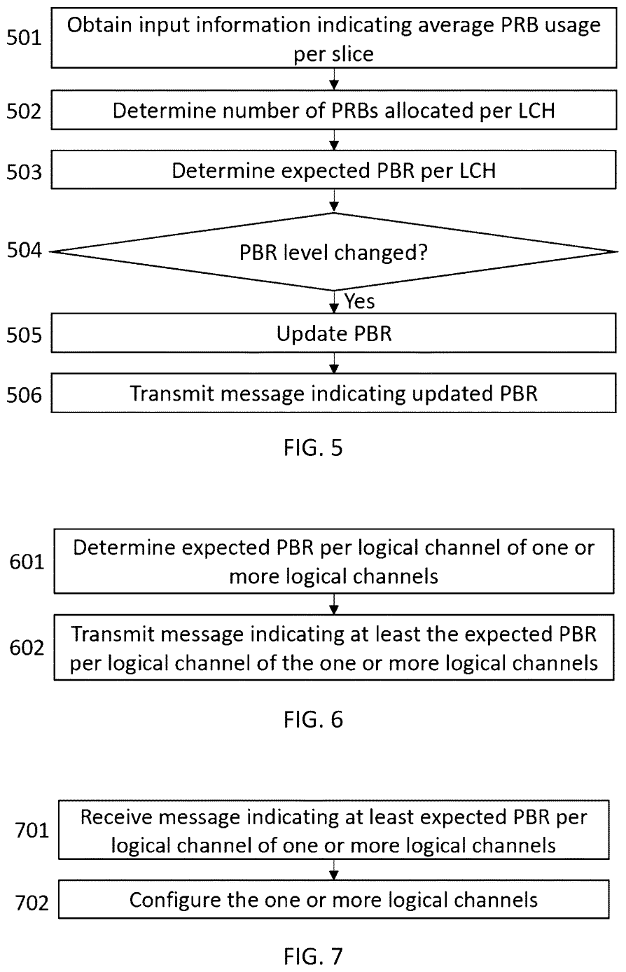

At LCH setup, a signaling or GBR LCH may be configured with a higher priority (smaller priority value according to TS 38.331) than any non-GBR LCH. In addition, the PBR of a signaling LCH may be set to 15 (infinity), which means that if a signaling LCH gets a chance to be scheduled, its buffer should be emptied, if there are sufficient cell resources available. The PBR of a GBR LCH should be set according to its guaranteed bit rate. On the other hand, at LCH setup, the priorities of non-GBR LCHs may be set to lower values (larger priority value) than any signaling or GBR LCH. One way to differentiate priorities among non-GBR LCHs is to set non-GBR LCHs of the same LCG to the same priority (e.g., LCHs in LCG IDs 1 & 2 in Table 1 are configured with the same priority and are hence treated equally), and to set non-GBR LCHs of a LCG with a high QoS requirement to a high priority (e.g., LCHs in LCG ID 3 in Table 1 are configured with a higher priority than LCHs in LCG IDs 1 & 2 due to the stricter QoS requirement of low latency applications). Initially, the PBR of a non-GBR LCH may be set to the expected throughput of the LCH or according to the PBR update algorithm, which is described below at 404 and in FIG. 5.

At 402, the UE transmits an RRC reconfiguration complete message to the gNB to indicate that the UE has successfully applied the configuration parameters comprised in the RRC reconfiguration message.

At 403, the gNB performs a PRB efficiency measurement of the UE for one or more LCHs. The PRB efficiency indicates the relation between PRB usage and data rate (throughput). The gNB may perform the PRB efficiency measurement continuously. The PRB efficiency may also be referred to as spectral efficiency herein.

The goal of the PRB efficiency measurement is to maintain an up-to-date model between PRB and throughput for a given UE. This model may be used for the PBR update at 404. More specifically, for a UE u, the model may be represented by Q=fᵤ(R), where Q is the throughput measured in bytes, and R is the number of PRBs that is expected to offer such a throughput. For simplicity, we can assume that fᵤ is a linear function, i.e., Q=cᵤ(t)·R, wherein cᵤ(t) denotes the PRB efficiency of UE u at UL slot t. A larger cᵤ(t) corresponds to a better channel quality.

The PRB efficiency of the UE is time-variant due to the UE mobility and changes in the radio environment. The PRB efficiency may be updated as frequently as possible, for example whenever the UE is scheduled in a UL slot, if the computation overhead is acceptable. In particular, at the current slot t, the PRB efficiency of a UE u can be estimated as follows. Let t′ be the most recent UL slot, in which UE u was scheduled, then:

$${c}_{u} ( t ) = \frac{{Q}_{u} ( {t}^{′} )}{{R}_{u} ( {t}^{′} )}$$

where Qᵤ(t′) is the UL data transmitted (in number of bytes) by UE u in slot t′, and Rᵤ(t′) is the number of PRBs used by UE u in slot t′.

For a lower computation overhead, another option is to collect a set of (Qᵤ(tᵢ), Rᵤ(tᵢ)) points corresponding to a number of previous UL slots in which UE u was scheduled, and to estimate the PRB efficiency cᵤ(t) with linear regression at the current slot t. This option has the additional advantage of providing a more stable PRB efficiency measurement, over a longer estimation interval (e.g., 10, 20 or 50 ms), which may be beneficial for infrequent PBR update. Suppose there are a set of points (Qᵤ(tᵢ), Rᵤ(tᵢ)), where i=1, . . . , N and t₁<t₂< . . . <t_{N}=t. The PRB efficiency cᵤ(t) can be found by minimizing the sum of squared error (SSE):

$$E ( {c}_{u} ( t ) ) = {\sum }_{i = 1}^{N} {( {Q}_{u} ( {t}_{i} ) - {c}_{u} ( t ) \cdot {R}_{u} ( {t}_{i} ) )}^{2}$$

By setting

$$\frac{d E ( {c}_{u} ( t ) )}{d {c}_{u} ( t )} = 0 ,$$

we have:

$${c}_{u} ( t ) = \frac{{\sum }_{i = 1}^{N} ( {R}_{u} ( {t}_{i} ) \cdot {Q}_{u} ( {t}_{i} ) )}{{\sum }_{i = 1}^{N} {( {R}_{u} ( {t}_{i} ) )}^{2}}$$

At 404, based on the PRB efficiency measurement, the gNB updates the expected PBR for the one or more LCHs, i.e., selects suitable PBR levels for the one or more LCHs. The gNB may perform the PBR update continuously.

For example, there may be a radio access control unit in a cell which makes sure that the average GBR traffic of a slice shall not use more than the target share of cell resources for that slice. The target share indicates an expected proportion of radio resources allocated for slice i in a cell divided into a plurality of slices. For slice i, let the target share be

$${A}_{i}^{t a r} ,$$

and the average (e.g., exponential moving average) resource share allocated to GBR traffic at UL slot t be

$${A}_{i}^{avg ( GBR )} ( t ) .$$

Then, the expected average resource share to be allocated to non-GBR traffic may be estimated as:

$${A}_{i}^{exp ( nGBR )} ( t ) = {A}_{i}^{tar} - {A}_{i}^{avg ( GBR )} ( t )$$

Let the average number of PRBs corresponding to the cell resources for data communication be M, and let a non-GBR LCH j of slice i have a weight wⱼ, where wⱼ is proportional to the expected amount of resources allocated to the LCH j among non-GBR LCHs of slice i. The expected number of PRBs allocated to LCH j per slot may be determined as:

$${M}_{i}^{exp} ( t ) = {A}_{i}^{exp ( nGBR )} ( t ) \cdot M \cdot \frac{{w}_{j}}{{\sum }_{k ∈ {L}_{i}^{nGBR}} {w}_{k}}$$

$$where {L}_{i}^{nGBR}$$

is the set of non-GBR LCHs of slice i. Let LCH j belong to a UE u and assume that in average there is one UL slot per time T (in seconds).

Applying the measured PRB efficiency cᵤ(t), the expected PBR of LCH j may be determined as:

$${P}_{j} ( t ) = \frac{{M}_{j}^{exp} ( t ) \cdot {c}_{u} ( t )}{T}$$

According to the LogicalChannelConfig in TS 38.331, PBR may be a value between 0 to 15, corresponding to 0 kBps, 8 kBps, 16 kBps, . . . , 65536 kBps and infinity. Based on Pⱼ(t), we get the PBR level

$${P}_{j}^{level} ( t )$$

between 0 and 14, which corresponds to the highest PBR that is lower than or equal to Pⱼ(t).

### Finally, if

$${P}_{j}^{level} ( t )$$

has been changed tor an LCH j compared to a previously configured PBR level of the LCH j, then the related PBR reconfiguration command may be sent for example in a first-come-first-serve manner. The LCH reconfiguration may happen when at least one of the following conditions has been changed: GBR load of a slice, LCH or slice configuration, and/or PRB efficiency of the UE. Normally, one LCH reconfiguration MAC CE may be sufficient for the PBR reconfiguration of all LCHs of a given UE, as they may share the same PBR timeout interval (described below). After a PBR timeout, the PBR value of the associated LCH is restored to the default value (set by RRC reconfiguration at 401). The timeout mechanism can be used to temporarily increase or decrease PBR, and hence the throughput of a LCH for a predefined duration.

At 405, if the PBR level of at least one LCH has been changed as a result of the PBR update, the gNB transmits, to the UE, an LCH reconfiguration MAC CE indicating the PBR to be updated for one or more related LCHs.

Transmitting the PBR reconfiguration via MAC CE may reduce overhead compared to transmitting it via RRC reconfiguration, as RRC reconfiguration may incur a longer delay. To support this feature, the current MAC CEs may be extended to include a new MAC CE LCH reconfiguration. The MAC CE LCH reconfiguration is general-purpose and supports the reconfiguration of at least three LCH parameters that may be associated with the LCP procedure: priority, prioritisedBitRate and bucketSizeDuration. For example, the LCH reconfiguration MAC CE may use a reserved logical channel identifier (LCID)=33, and the payload listed in Table 2 below. Herein the LCH reconfiguration MAC CE is designed in a more general way, because there may be multiple ways to do UL slicing. For example, the UL slicing may be done by dynamically adjusting the priority of LCHs, so that LCHs with higher priority get served first.

TABLE 2
Example of LCH reconfiguration MAC CE

| | | | | | | | |
|---|---|---|---|---|---|---|---|
| 1 bit | 1 bit | 1 bit | 1 bit | 1 bit | 1 bit | 1 bit | 1 bit |

| | | | |
|---|---|---|---|
| TIMEOUT | BSD bit | PBR bit | PRIO |

bit

| | |
|---|---|
| LCID#1 | LCID NUMBER |

| | |
|---|---|
| LCID#2 | LCID#1 (cont.) |

| | | |
|---|---|---|
| . . . | LCID#3 | LCID#2 |

| | | (cont.) |
|---|---|---|
| PRIO#1 | . . . | |
| PRIO#3 | PRIO#2 | PRIO#1 |
| PBR#1 | . . . | PRIO#3 |
| PBR#3 | PBR#2 | PBR#1 |
| | | (cont.) |
| BSD#1 | . . . | PBR#3 |
| | | (cont.) |
| BSD#3 | BSD#2 | BSD#1 |
| | | (cont.) |
| | . . . | BSD#3 |

(cont.)

If the PRIO bit is set, then the PRIO block is included in the MAC CE. The PRIO block indicates the priority to be configured for the relevant logical channel(s).

If the PBR BIT is set, then the PBR block is included in the MAC CE. The PBR block indicates the PBR (prioritisedBitRate) to be configured for the relevant logical channel(s).

If the BSD bit is set, then the BSD block is included in the MAC CE. The BSD block indicates the BSD (bucketSizeDuration) to be configured for the relevant logical channel(s).

The LCID number represents the number of logical channels, for which the PBR reconfiguration should be done. For example, the value of the LCID number may range from 0 to 31, representing 1 to 32 logical channels.

LCID #i represents the i-th logical channel's 6-bit identifier.

PRIO #i represents the priority value to update (configure) for the i-th logical channel. It may be defined according to the priority in LogicalChannelConfig. For example, the value may range from 0 to 15, representing priority value 1 to 16. If the PRIO bit is set, the PRIO block may comprise 4*(LCID Number) bits.

PBR #i represents the PBR value to update (configure) for the i-th logical channel. It may be defined in the same way as the prioritisedBitRate in LogicalChannelConfig. For example, the PBR value may range from 0 to 15, representing 0, 8, 16, . . . , 32768, 65536 kilobytes per second, and infinity. If the PBR bit is set, the PBR block may comprise 4*(LCID Number) bits.

BSD #i represents the BSD value to update (configure) for the i-th logical channel. It may be defined according to the bucketSizeDuration in LogicalChannelConfig. For example, the BSD value may range from 0 to 8, representing 5, 10, 20, 50, 100, 150, 300, 500 and 1000 milliseconds. If the BSD BIT is set, the BSD block may comprise 4*(LCID Number) bits.

The TIMEOUT in Table 2 indicates the timeout interval (e.g., measured in milliseconds). If TIMEOUT=0, the timeout interval may be set to infinity. Otherwise, the timeout interval may be equal to 2\hat{ }(TIMEOUT−1) milliseconds, for example ranging from 1 millisecond to 298.26 hours. Three timers may be created for a given LCH at the time of LCH setup, for the three parameters of priority, PBR and BSD, respectively. Initially, all three timers may be deactivated. When an LCH reconfiguration MAC CE is received by the UE, if TIMEOUT #0, then the related timers (depending on the PRIO, PBR and BSD bits) of all LCHs indicated in the MAC CE may be activated with the indicated timeout interval. If TIMEOUT=0, then the related timers (depending on the PRIO, PBR and BSD bits) of all LCHs indicated in the MAC CE may be deactivated. After the timeout of a given timer, the associated parameter (priority, PBR or BSD) is set to the default value (i.e., the value set by the RRC reconfiguration at 401). For example, an aggressive LCH reconfiguration may offer fast convergence to the target share and use a small timeout interval.

At 406, based on the received LCH reconfiguration MAC CE, the UE configures the one or more logical channels indicated in the LCH reconfiguration MAC CE.

If the PRIO BIT is set in the LCH reconfiguration MAC CE, the one or more logical channels are configured with the related PRIO value.

If the PBR BIT is set in the LCH reconfiguration MAC CE, the one or more logical channels are configured with the related PBR value.

If the BSD BIT is set in the LCH reconfiguration MAC CE, the one or more logical channels are configured with the related BSD value.

The reconfigured values may have a lifetime duration, if the timeout interval is nonzero. Otherwise, they may be permanent until they are modified by another LCH reconfiguration MAC CE in the future.

At 407, the UE may transmit a buffer status report (BSR) to the gNB to inform the gNB about the amount of data that the UE has buffered for transmission. The gNB may use the BSR information to determine whether to grant additional uplink resources to the UE to support transmission of the buffered data.

At 408, based on the buffer status report, the gNB determines and transmits one or more uplink grants to the UE. The one or more uplink grants may be transmitted on a PDCCH per uplink slot. For the UE to be scheduled in an uplink slot, the one or more uplink grants may be determined such that they provide so much frequency domain resources that the following two requirements are satisfied: 1) a given GBR LCH is assigned PRBs such that in average its guaranteed bit rate requirement is satisfied; and 2) the non-GBR LCH(s) are assigned PRBs such that at a slot t, a given slice i approaches its resource share for non-GBR traffic according to

$${A}_{i}^{exp ( nGBR )} ( t )$$

(see the PBR update at 404 above), if multiple slices are competing for the cell resources. Herein “approaches” means that the actual resource share of the non-GBR traffic of slice i is as close as possible to the expected average resource share

$${A}_{i}^{exp ( nGBR )} ( t ) .$$

In other words, the one or more uplink grants may be determined by assigning radio resources to one or more guaranteed bit rate logical channels of slice i such that the guaranteed bit rate requirement is satisfied, and by assigning radio resources to one or more non-guaranteed bit rate logical channels of slice i based on the expected average resource share to be allocated for the non-guaranteed bit rate traffic of the slice.

At 409, based on the expected prioritized bit rate per logical channel of the one or more logical channels indicated in the LCH reconfiguration MAC CE at 405, the UE allocates the one or more received uplink grants to the one or more logical channels using the LCP procedure.

At 410, in case of a timeout, the UE restores the default priority, PBR and/or BSD for the one or more related LCHs. In other words, after the timeout of a timer, the associated parameter (priority, PBR and/or BSD) is set to the default value (i.e., the value set by the RRC reconfiguration at 401).

The UL slicing control method described above may have several advantages. Firstly, the UE is slice-agnostic and thus the slicing configuration and algorithm can be updated by changing just the gNB behaviour. Secondly, the modification to the 3GPP standard is minimal and has little impact on UEs. Thirdly, the extra communication overhead due to the UL slicing control is low.

FIG. 5 illustrates a flow chart according to an example embodiment of a method performed by an apparatus. For example, the apparatus may be, or comprise, or be comprised in, a network node of a radio access network. The network node may correspond to the access node 104 of FIG. 1, or the gNB 220 of FIG. 2, or the gNB of FIG. 4.

The algorithm illustrated in FIG. 5 may be run every N slots. The goal of the algorithm is to allow a given slice to meet its target resource usage. The algorithm may be run in block 404 of FIG. 4.

Referring to FIG. 5, in block 501, input information is obtained, wherein the input information indicates an average PRB usage (resource usage) per slice (e.g., as a percentage). The average PRB usage refers to

$${A}_{i}^{a v g ( G B R )} ( t ) and {A}_{i}^{exp ( nGBR )} ( t )$$

defined above.

As described above at 404, the expected average resource share

$${A}_{i}^{exp ( nGBR )} ( t )$$

to be allocated for non-guaranteed bit rate traffic of the slice in at least one time slot may be estimated by subtracting the average resource share

$${A}_{i}^{avg ( GBR )} ( t )$$

allocated for guaranteed bit rate traffic of the slice in the at least one time slot from the target share

$${A}_{i}^{t a r}$$

or the slice.

In block 502, based on the target share and average PRB usage per slice, the expected number of PRBs (i.e., amount of radio resources) allocated per logical channel per slot is determined. The expected number of PRBs refers to

$${M}_{j}^{exp} ( t )$$

defined above.

As described above at 404, the expected number of physical resource blocks

$${M}_{j}^{exp} ( t )$$

allocated per the logical channel of the one or more logical channels of the slice in the at least one time slot may be determined based at least on the expected average resource share

$${A}_{i}^{exp ( nGBR )} ( t )$$

to be allocated for the non-guaranteed bit rate traffic of the slice in the at least one time slot.

The expected number of physical resource blocks

$${M}_{j}^{exp} ( t )$$

may be determined based further on a weight value wⱼ of the logical channel, the weight value being proportional to an expected amount of radio resources allocated to the logical channel among the one or more logical channels of the slice.

In block 503, based at least on the expected number of physical resource blocks

$${M}_{j}^{exp} ( t )$$

allocated per the logical channel, and the spectral efficiency cᵤ(t) (determined at 403 of FIG. 4) of the at least one UE, the expected PBR per logical channel may be determined. The expected PBR refers to Pⱼ(t) defined above at 404.

In block 504, it is determined whether the PBR level for at least one logical channel of the at least one UE has changed compared to a previously configured PBR level of the at least one logical channel. The PBR level refers to

$${P}_{j}^{level} ( t )$$

defined above at 404.

In block 505, based on determining that the PBR level has changed (block 504: yes), the expected PBR for one or more related logical channels of the at least one UE is updated to the closest PBR level below or equal to the expected PBR.

In block 506, a message (e.g., MAC CE) indicating the updated PBR is transmitted to the at least one UE.

FIG. 6 illustrates a flow chart according to an example embodiment of a method performed by an apparatus. For example, the apparatus may be, or comprise, or be comprised in, a network node of a radio access network. The network node may correspond to the access node 104 or DU 105 or CU 108 of FIG. 1, or the gNB 220 of FIG. 2, or the gNB of FIG. 4.

Referring to FIG. 6, in block 601, the apparatus determines an expected prioritized bit rate per a logical channel 311 of one or more logical channels 311, 312, 313 based at least on a spectral efficiency of at least one user device 230 and a target share of a slice 331, the at least one user device 230 being configured to communicate with the slice 331 via the logical channel 311, wherein the target share indicates an expected proportion of radio resources allocated for the slice 331 in a cell divided into a plurality of slices 331, 332, 333. The expected prioritized bit rate may refer to an expected prioritized bit rate level

$${P}_{j}^{level} ( t ) .$$

The cell being divided into a plurality of slices may mean that the radio resources of the cell are divided to the plurality of slices.

For example, the expected prioritized bit rate per the logical channel may be determined by: estimating an expected average resource share to be allocated for non-guaranteed bit rate traffic of the slice in at least one time slot by subtracting an average resource share allocated for guaranteed bit rate traffic of the slice in the at least one time slot from the target share of the slice; determining, based at least on the expected average resource share to be allocated for the non-guaranteed bit rate traffic of the slice in the at least one time slot, an expected number of physical resource blocks allocated per the logical channel of the one or more logical channels of the slice in the at least one time slot; and determining the expected prioritized bit rate per the logical channel of the one or more logical channels based at least on the expected number of physical resource blocks allocated per the logical channel, and the spectral efficiency of the at least one user device.

The expected number of physical resource blocks allocated per the logical channel may be determined based further on a weight value of the logical channel, the weight value being proportional to an expected amount of radio resources allocated to the logical channel among the one or more logical channels of the slice.

In block 602, the apparatus transmits, to the at least one user device, a message indicating at least the expected prioritized bit rate per the logical channel of the one or more logical channels. For example, the message may comprise a value indicating the expected prioritized bit rate per the logical channel (e.g., one PBR value per logical channel). For example, the message may be a MAC CE message.

The message may further indicate at least one of: a priority per the logical channel of the one or more logical channels, or a bucket size duration per the logical channel of the one or more logical channels. For example, the message may comprise a value indicating the priority per the logical channel (e.g., one priority value per logical channel), and/or a value indicating the bucket size duration per the logical channel (e.g., one BSD value per logical channel).

The message may further indicate a timeout interval, wherein the timeout interval indicates to restore, after the timeout interval expires, at least one of: a default expected prioritized bit rate per the logical channel of the one or more logical channels, a default priority per the logical channel of the one or more logical channels, or a default bucket size duration per the logical channel of the one or more logical channels.

The message may be transmitted based on detecting a change in a level of the expected prioritized bit rate per the logical channel compared to a level of a previously configured expected prioritized bit rate of the logical channel.

The apparatus may further determine one or more uplink grants for the at least one user device by: assigning radio resources to one or more guaranteed bit rate logical channels of the slice, such that a guaranteed bit rate requirement is satisfied, and assigning radio resources to one or more non-guaranteed bit rate logical channels of the slice, based on the expected average resource share to be allocated for the non-guaranteed bit rate traffic of the slice. The apparatus may transmit the one or more uplink grants to the at least one user device.

The message may cause the at least one user device to allocate the one or more uplink grants to the one or more logical channels based on the expected prioritized bit rate per the logical channel of the one or more logical channels.

FIG. 7 illustrates a flow chart according to an example embodiment of a method performed by an apparatus. For example, the apparatus may be, or comprise, or be comprised in, a user device. The user device may also be called a wireless communication device, a subscriber unit, a mobile station, a remote terminal, an access terminal, a user terminal, a terminal device, or user equipment (UE). The user device may correspond to one of the UEs 100, 102 of FIG. 1, or the UE 230 of FIG. 2, or the UE of FIG. 4.

Referring to FIG. 7, in block 701, the apparatus receives a message indicating at least an expected prioritized bit rate per a logical channel 311 of one or more logical channels 311, 312, 313. For example, the message may comprise a value indicating the expected prioritized bit rate (e.g., one PBR value per logical channel). For example, the message may be a MAC CE message. The message may be received from a network node of a radio access network, such as the access node 104 or DU 105 of FIG. 1, or the gNB 220 of FIG. 2, or the gNB of FIG. 4.

In block 702, the apparatus configures the one or more logical channels 311, 312, 313 by applying at least the expected prioritized bit rate per the logical channel 311 of the one or more logical channels 311, 312, 313. For example, the apparatus may apply the expected prioritized bit rate value per the logical channel 311 of the one or more logical channels 311, 312, 313.

The expected prioritized bit rate is based at least on a spectral efficiency of the apparatus and a target share of a slice 331, the apparatus being configured to communicate with the slice 331 via the logical channel 311. The target share indicates an expected proportion of radio resources allocated for the slice 331 in a cell divided into a plurality of slices 331, 332, 333.

The apparatus may allocate, based on the expected prioritized bit rate per the logical channel of the one or more logical channels, one or more received uplink grants to the one or more logical channels.

The message may further indicate at least one of: a priority per the logical channel of the one or more logical channels, or a bucket size duration per the logical channel of the one or more logical channels. For example, the message may comprise a value indicating the priority per the logical channel (e.g., one priority value per logical channel), and/or a value indicating the bucket size duration per the logical channel (e.g., one BSD value per logical channel). The apparatus may configure the one or more logical channels by applying the at least one of: the priority per the logical channel of the one or more logical channels, or the bucket size duration per the logical channel of the one or more logical channels.

The message may further indicate a timeout interval. The apparatus may restore, after the timeout interval expires, at least one of: a default expected prioritized bit rate per the logical channel of the one or more logical channels, a default priority per the logical channel of the one or more logical channels, or a default bucket size duration per the logical channel of the one or more logical channels. In other words, the apparatus may restore the configured PBR value, priority value, and/or BSD value of a given logical channel to the respective default value after the timeout interval expires.

The blocks, related functions, and information exchanges (messages) described above by means of FIGS. 4-7 are in no absolute chronological order, and some of them may be performed simultaneously or in an order differing from the described one. Other functions can also be executed between them or within them, and other information may be sent, and/or other rules applied. Some of the blocks or part of the blocks or one or more pieces of information can also be left out or replaced by a corresponding block or part of the block or one or more pieces of information.

As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

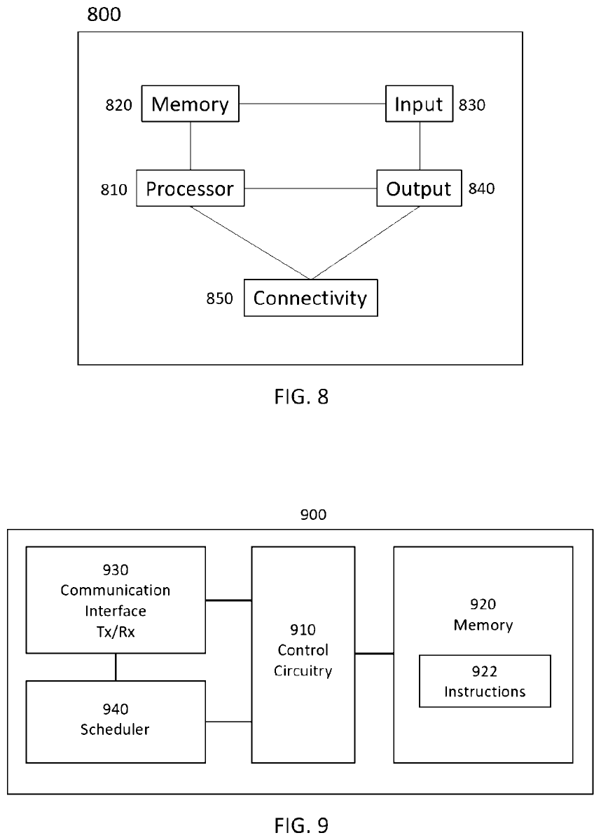

FIG. 8 illustrates an example of an apparatus 800 comprising means for performing one or more of the example embodiments described above. For example, the apparatus 800 may be an apparatus such as, or comprising, or comprised in, a user device. The user device may also be called a wireless communication device, a subscriber unit, a mobile station, a remote terminal, an access terminal, a user terminal, a terminal device, or user equipment (UE). The user device may correspond to one of the UEs 100, 102 of FIG. 1, or the UE 230 of FIG. 2, or the UE of FIG. 4.

The apparatus 800 may comprise a circuitry or a chipset applicable for realizing one or more of the example embodiments described above. For example, the apparatus 800 may comprise at least one processor 810. The at least one processor 810 interprets instructions (e.g., computer program instructions) and processes data. The at least one processor 810 may comprise one or more programmable processors. The at least one processor 810 may comprise programmable hardware with embedded firmware and may, alternatively or additionally, comprise one or more application-specific integrated circuits (ASICs).

The at least one processor 810 is coupled to at least one memory 820. The at least one processor is configured to read and write data to and from the at least one memory 820. The at least one memory 820 may comprise one or more memory units. The memory units may be volatile or non-volatile. It is to be noted that there may be one or more units of non-volatile memory and one or more units of volatile memory or, alternatively, one or more units of non-volatile memory, or, alternatively, one or more units of volatile memory. Volatile memory may be for example random-access memory (RAM), dynamic random-access memory (DRAM) or synchronous dynamic random-access memory (SDRAM). Non-volatile memory may be for example read-only memory (ROM), programmable read-only memory (PROM), electronically erasable programmable read-only memory (EEPROM), flash memory, optical storage or magnetic storage. In general, memories may be referred to as non-transitory computer readable media. The term “non-transitory,” as used herein, is a limitation of the medium itself (i.e., tangible, not a signal) as opposed to a limitation on data storage persistency (e.g., RAM vs. ROM). The at least one memory 820 stores computer readable instructions that are executed by the at least one processor 810 to perform one or more of the example embodiments described above. For example, non-volatile memory stores the computer readable instructions, and the at least one processor 810 executes the instructions using volatile memory for temporary storage of data and/or instructions. The computer readable instructions may refer to computer program code.

The computer readable instructions may have been pre-stored to the at least one memory 820 or, alternatively or additionally, they may be received, by the apparatus, via an electromagnetic carrier signal and/or may be copied from a physical entity such as a computer program product. Execution of the computer readable instructions by the at least one processor 810 causes the apparatus 800 to perform one or more of the example embodiments described above. That is, the at least one processor and the at least one memory storing the instructions may provide the means for providing or causing the performance of any of the methods and/or blocks described above.

In the context of this document, a “memory” or “computer-readable media” or “computer-readable medium” may be any non-transitory media or medium or means that can contain, store, communicate, propagate or transport the instructions for use by or in connection with an instruction execution system, apparatus, or device, such as a computer. The term “non-transitory,” as used herein, is a limitation of the medium itself (i.e., tangible, not a signal) as opposed to a limitation on data storage persistency (e.g., RAM vs. ROM).

The apparatus 800 may further comprise, or be connected to, an input unit 830. The input unit 830 may comprise one or more interfaces for receiving input. The one or more interfaces may comprise for example one or more temperature, motion and/or orientation sensors, one or more cameras, one or more accelerometers, one or more microphones, one or more buttons and/or one or more touch detection units. Further, the input unit 830 may comprise an interface to which external devices may connect to.

The apparatus 800 may also comprise an output unit 840. The output unit may comprise or be connected to one or more displays capable of rendering visual content, such as a light emitting diode (LED) display, a liquid crystal display (LCD) and/or a liquid crystal on silicon (LCOS) display. The output unit 840 may further comprise one or more audio outputs. The one or more audio outputs may be for example loudspeakers.

The apparatus 800 further comprises a connectivity unit 850. The connectivity unit 850 enables wireless connectivity to one or more external devices. The connectivity unit 850 comprises at least one transmitter and at least one receiver that may be integrated to the apparatus 800 or that the apparatus 800 may be connected to. The at least one transmitter comprises at least one transmission antenna, and the at least one receiver comprises at least one receiving antenna. The connectivity unit 850 may comprise an integrated circuit or a set of integrated circuits that provide the wireless communication capability for the apparatus 800. Alternatively, the wireless connectivity may be a hardwired application-specific integrated circuit (ASIC). The connectivity unit 850 may also provide means for performing at least some of the blocks of one or more example embodiments described above. The connectivity unit 850 may comprise one or more components, such as: power amplifier, digital front end (DFE), analog-to-digital converter (ADC), digital-to-analog converter (DAC), frequency converter, (de) modulator, and/or encoder/decoder circuitries, controlled by the corresponding controlling units.

It is to be noted that the apparatus 800 may further comprise various components not illustrated in FIG. 8. The various components may be hardware components and/or software components.

FIG. 9 illustrates an example of an apparatus 900 comprising means for performing one or more of the example embodiments described above. For example, the apparatus 900 may be an apparatus such as, or comprising, or comprised in, a network node of a radio access network. The network node may correspond to the access node 104 or DU 105 or CU 108 of FIG. 1, or the gNB 220 of FIG. 2, or the gNB of FIG. 4.

The network node may also be referred to, for example, as a network element, a radio access network (RAN) node, a next generation radio access network (NG-RAN) node, a NodeB, an eNB, a gNB, a base transceiver station (BTS), a base station, an NR base station, a 5G base station, an access node, an access point (AP), a relay node, a repeater, an integrated access and backhaul (IAB) node, an IAB donor node, a distributed unit (DU), a central unit (CU), a baseband unit (BBU), a radio unit (RU), a radio head, a remote radio head (RRH), or a transmission and reception point (TRP).

The apparatus 900 may comprise, for example, a circuitry or a chipset applicable for realizing one or more of the example embodiments described above. The apparatus 900 may be an electronic device comprising one or more electronic circuitries. The apparatus 900 may comprise a communication control circuitry 910 such as at least one processor, and at least one memory 920 storing instructions 922 which, when executed by the at least one processor, cause the apparatus 900 to carry out one or more of the example embodiments described above. Such instructions 922 may, for example, include computer program code (software). The at least one processor and the at least one memory storing the instructions may provide the means for providing or causing the performance of any of the methods and/or blocks described above.

The processor is coupled to the memory 920. The processor is configured to read and write data to and from the memory 920. The memory 920 may comprise one or more memory units. The memory units may be volatile or non-volatile. It is to be noted that there may be one or more units of non-volatile memory and one or more units of volatile memory or, alternatively, one or more units of non-volatile memory, or, alternatively, one or more units of volatile memory. Volatile memory may be for example random-access memory (RAM), dynamic random-access memory (DRAM) or synchronous dynamic random-access memory (SDRAM). Non-volatile memory may be for example read-only memory (ROM), programmable read-only memory (PROM), electronically erasable programmable read-only memory (EEPROM), flash memory, optical storage or magnetic storage. In general, memories may be referred to as non-transitory computer readable media. The term “non-transitory,” as used herein, is a limitation of the medium itself (i.e., tangible, not a signal) as opposed to a limitation on data storage persistency (e.g., RAM vs. ROM). The memory 920 stores computer readable instructions that are executed by the processor. For example, non-volatile memory stores the computer readable instructions, and the processor executes the instructions using volatile memory for temporary storage of data and/or instructions.

The computer readable instructions may have been pre-stored to the memory 920 or, alternatively or additionally, they may be received, by the apparatus, via an electromagnetic carrier signal and/or may be copied from a physical entity such as a computer program product. Execution of the computer readable instructions causes the apparatus 900 to perform one or more of the functionalities described above.

The memory 920 may be implemented using any suitable data storage technology, such as semiconductor-based memory devices, flash memory, magnetic memory devices and systems, optical memory devices and systems, fixed memory and/or removable memory. The memory may comprise a configuration database for storing configuration data, such as a current neighbour cell list, and, in some example embodiments, structures of frames used in the detected neighbour cells.

The apparatus 900 may further comprise or be connected to a communication interface 930, such as a radio unit, comprising hardware and/or software for realizing communication connectivity with one or more wireless communication devices according to one or more communication protocols. The communication interface 930 comprises at least one transmitter (Tx) and at least one receiver (Rx) that may be integrated to the apparatus 900 or that the apparatus 900 may be connected to. The communication interface 930 may provide means for performing some of the blocks for one or more example embodiments described above. The communication interface 930 may comprise one or more components, such as: power amplifier, digital front end (DFE), analog-to-digital converter (ADC), digital-to-analog converter (DAC), frequency converter, (de) modulator, and/or encoder/decoder circuitries, controlled by the corresponding controlling units.

The communication interface 930 provides the apparatus with radio communication capabilities to communicate in the wireless communication network. The communication interface may, for example, provide a radio interface to one or more wireless communication devices. The apparatus 900 may further comprise or be connected to another interface towards a core network such as the network coordinator apparatus or AMF, and/or to the access nodes of the cellular communication system.

The apparatus 900 may further comprise a scheduler 940 that is configured to allocate radio resources. The scheduler 940 may be configured along with the communication control circuitry 910 or it may be separately configured.

It is to be noted that the apparatus 900 may further comprise various components not illustrated in FIG. 9. The various components may be hardware components and/or software components.

As used in this application, the term “circuitry” may refer to one or more or all of the following: a) hardware-only circuit implementations (such as implementations in only analog and/or digital circuitry); and b) combinations of hardware circuits and software, such as (as applicable): i) a combination of analog and/or digital hardware circuit(s) with software/firmware and ii) any portions of hardware processor(s) with software (including digital signal processor(s), software, and memory(ies) that work together to cause an apparatus, such as a mobile phone, to perform various functions); and c) hardware circuit(s) and/or processor(s), such as a microprocessor(s) or a portion of a microprocessor(s), that requires software (for example firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

The techniques and methods described herein may be implemented by various means. For example, these techniques may be implemented in hardware (one or more devices), firmware (one or more devices), software (one or more modules), or combinations thereof. For a hardware implementation, the apparatus(es) of example embodiments may be implemented within one or more application-specific integrated circuits (ASICs), digital signal processors (DSPs), digital signal processing devices (DSPDs), programmable logic devices (PLDs), field programmable gate arrays (FPGAs), graphics processing units (GPUs), processors, controllers, micro-controllers, microprocessors, other electronic units designed to perform the functions described herein, or a combination thereof. For firmware or software, the implementation can be carried out through modules of at least one chipset (for example procedures, functions, and so on) that perform the functions described herein. The software codes may be stored in a memory unit and executed by processors. The memory unit may be implemented within the processor or externally to the processor. In the latter case, it can be communicatively coupled to the processor via various means, as is known in the art. Additionally, the components of the systems described herein may be rearranged and/or complemented by additional components in order to facilitate the achievements of the various aspects, etc., described with regard thereto, and they are not limited to the precise configurations set forth in the given figures, as will be appreciated by one skilled in the art.

It will be obvious to a person skilled in the art that, as technology advances, the inventive concept may be implemented in various ways. The embodiments are not limited to the example embodiments described above, but may vary within the scope of the claims. Therefore, all words and expressions should be interpreted broadly, and they are intended to illustrate, not to restrict, the embodiments.

1. An apparatus comprising at least one processor, and at least one memory storing instructions that, when executed by the at least one processor, cause the apparatus at least to:
determine an expected prioritized bit rate per a logical channel of one or more logical channels based at least on a spectral efficiency of at least one user device and a target share of a slice, the at least one user device being configured to communicate with the slice via the logical channel,
wherein the target share indicates an expected proportion of radio resources allocated for the slice in a cell divided into a plurality of slices; and
transmit, to the at least one user device, a message indicating at least the expected prioritized bit rate per the logical channel of the one or more logical channels,
wherein the message further indicates a timeout interval, wherein the timeout interval indicates to restore, after the timeout interval expires, at least one of: a default expected prioritized bit rate per the logical channel of the one or more logical channels, a default priority per the logical channel of the one or more logical channels, or a default bucket size duration per the logical channel of the one or more logical channels.

2. The apparatus according to claim 1, wherein the message is a medium access control, MAC, control element, CE, message.

3. The apparatus according to claim 1, wherein the message further indicates at least one of: a priority per the logical channel of the one or more logical channels, or a bucket size duration per the logical channel of the one or more logical channels.

4. (canceled)

5. The apparatus according to claim 1, wherein the message is transmitted based on detecting a change in a level of the expected prioritized bit rate per the logical channel compared to a level of a previously configured expected prioritized bit rate of the logical channel.

6. The apparatus according to claim 1, further being caused to:
estimate an expected average resource share to be allocated for non-guaranteed bit rate traffic of the slice in at least one time slot by subtracting an average resource share allocated for guaranteed bit rate traffic of the slice in the at least one time slot from the target share of the slice; and
determine, based at least on the expected average resource share to be allocated for the non-guaranteed bit rate traffic of the slice in the at least one time slot, an expected number of physical resource blocks allocated per the logical channel of the one or more logical channels of the slice in the at least one time slot,
wherein the expected prioritized bit rate per the logical channel of the one or more logical channels is determined based at least on the expected number of physical resource blocks allocated per the logical channel, and the spectral efficiency of the at least one user device.

7. The apparatus according to claim 6, wherein the expected number of physical resource blocks allocated per the logical channel is determined based further on a weight value of the logical channel, the weight value being proportional to an expected amount of radio resources allocated to the logical channel among the one or more logical channels of the slice.

8. The apparatus according to claim 6, further being caused to:
determine one or more uplink grants for the at least one user device by:
assigning radio resources to one or more guaranteed bit rate logical channels of the slice, such that a guaranteed bit rate requirement is satisfied, and
assigning radio resources to one or more non-guaranteed bit rate logical channels of the slice, based on the expected average resource share to be allocated for the non-guaranteed bit rate traffic of the slice; and
transmit the one or more uplink grants to the at least one user device.

9. The apparatus according to claim 8, wherein the message causes the at least one user device to allocate the one or more uplink grants to the one or more logical channels based on the expected prioritized bit rate per the logical channel of the one or more logical channels.

10. The apparatus according to claim 1, wherein the apparatus comprises, or is comprised in, a network node of a radio access network.

11. An apparatus comprising at least one processor, and at least one memory storing instructions that, when executed by the at least one processor, cause the apparatus at least to:
receive a message indicating at least an expected prioritized bit rate per a logical channel of one or more logical channels, wherein the message further indicates a timeout interval;
configure the one or more logical channels by applying at least the expected prioritized bit rate per the logical channel of the one or more logical channels,
wherein the expected prioritized bit rate is based at least on a spectral efficiency of the apparatus and a target share of a slice, the apparatus being configured to communicate with the slice via the logical channel,
wherein the target share indicates an expected proportion of radio resources allocated for the slice in a cell divided into a plurality of slices; and
restore, after the timeout interval expires, at least one of: a default expected prioritized bit rate per the logical channel of the one or more logical channels, a default priority per the logical channel of the one or more logical channels, or a default bucket size duration per the logical channel of the one or more logical channels.

12. The apparatus according to claim 11, further being caused to:
allocate, based on the expected prioritized bit rate per the logical channel of the one or more logical channels, one or more received uplink grants to the one or more logical channels.

13. The apparatus according to claim 11, wherein the message is a medium access control, MAC, control element, CE, message.

14. The apparatus according to claim 11, wherein the message further indicates at least one of: a priority per the logical channel of the one or more logical channels, or a bucket size duration per the logical channel of the one or more logical channels;
the apparatus being further caused to:
configure the one or more logical channels by applying the at least one of: the priority per the logical channel of the one or more logical channels, or the bucket size duration per the logical channel of the one or more logical channels.

15. (canceled)

16. The apparatus according to claim 11, wherein the apparatus comprises, or is comprised in, a user device.

17-22. (canceled)

23. A system comprising at least one user device and a network node of a radio access network,
wherein the network node is configured to:
determine an expected prioritized bit rate per a logical channel of one or more logical channels based at least on a spectral efficiency of the at least one user device and a target share of a slice, the at least one user device being configured to communicate with the slice via the logical channel,
wherein the target share indicates an expected proportion of radio resources allocated for the slice in a cell divided into a plurality of slices; and
transmit, to the at least one user device, a message indicating at least the expected prioritized bit rate per the logical channel of the one or more logical channels;
wherein the message further indicates a timeout interval, wherein the timeout interval indicates to restore, after the timeout interval expires, at least one of: a default expected prioritized bit rate per the logical channel of the one or more logical channels, a default priority per the logical channel of the one or more logical channels, or a default bucket size duration per the logical channel of the one or more logical channels,
wherein the at least one user device is configured to:
receive the message indicating at least the expected prioritized bit rate per the logical channel of the one or more logical channels, wherein the message further indicates the timeout interval;
configure the one or more logical channels by applying at least the expected prioritized bit rate per the logical channel of the one or more logical channels,
wherein the expected prioritized bit rate is based at least on a spectral efficiency of the apparatus and a target share of a slice, the apparatus being configured to communicate with the slice via the logical channel,
wherein the target share indicates an expected proportion of radio resources allocated for the slice in a cell divided into a plurality of slices; and
restore, after the timeout interval expires, at least one of: a default expected prioritized bit rate per the logical channel of the one or more logical channels, a default priority per the logical channel of the one or more logical channels, or a default bucket size duration per the logical channel of the one or more logical channels.
